(19) United States
(12) Patent Application Publication
(10) Pub. No.: US 2005/0035514 A1
(43) Pub. Date: Feb. 17, 2005

(54) Vacuum chuck apparatus and method for holding a wafer during high pressure processing

(75) Inventors: Joseph Hillman, Scottsdale, AZ (US); Dennis Conci, Scottsdale, AZ (US)

Correspondence Address: Thomas B. Haverstock;HAVERSTOCK & OWENS LLP, 162 North Wolfe Road, Sunnyvale, CA, 94086, US

(73) Assignee: Supercritical Systems, Inc.

(21) Appl. No.: 10/639,224

(22) Filed: Aug. 11, 2003

(51) Int. Cl. B25B 11/00; B23Q 7/00

(52) U.S. Cl. 269/21; 29/559

(57) ABSTRACT

Method and apparatus for holding a wafer having a wafer dimension during processing, the vacuum chuck comprising a concave wafer platen configured force the wafer into intimate contact with the wafer platen and provide a seal therebetween when high pressure is applied to the wafer. The wafer platen for preventing matter from entering between the wafer and vacuum chuck. A groove configured in the wafer platen applies vacuum to the underside of the wafer. A plenum configured in the platen provides pressure for a predetermined amount of time between the wafer and the vacuum chuck to disengage the wafer.

### FIELD OF THE INVENTION

The invention relates to an apparatus for processing of silicon wafers in general, and specifically, to a vacuum chuck having a wafer platen configured to prevent matter from entering between the wafer and wafer platen during processing.

### BACKGROUND OF THE INVENTION

It is common to use a vacuum chuck to hold silicon wafers in place for processing the wafer within a high processing chamber. FIGS. 1A and 1B illustrate a conventional flat, vacuum chuck. As shown in FIGS. 1A and 1B, conventional flat vacuum chucks 10 are utilized to hold the wafer 99, whereby one or more vacuum grooves 14 are machined into the wafer support surface or wafer platen 12 of the vacuum chuck. In particular, the vacuum groove or grooves 14 are concentrically positioned with respect to the center of the wafer support surface 12. In addition, a set of pins 16 are configured near the center of the wafer support surface 12 to effectively lower the wafer 99 onto wafer support surface 12 to process the wafer 99 as well as raise the wafer 99 off the wafer support surface 12 after processing of the wafer 99 has been completed. Conventionally, a wafer 99, preferably silicon, is placed concentrically from the center on the wafer support surface 12, whereby vacuum is applied through the vacuum groove or grooves 14 onto the backside 98 of the wafer to initially hold it in place during high pressure processing, as shown in FIG. 1B.

The largest outside diameter of the vacuum groove 14 is approximately 20 millimeters smaller than the outer diameter of the wafer 99. The difference between the outside diameter of the wafer and the vacuum groove is roughly 10 millimeters, which leaves a gap of 10 millimeters around the outer bottom edge 97 of the wafer 99. As stated, the backside of the wafer 98 is exposed to the vacuum applied diametrically within the vacuum groove 14 as well as the chamber ambient pressures applied diametrically outside of the vacuum groove 14. During high pressure processing, cleaning co-solvents are applied to the vacuum chuck 10 and wafer within the processing chamber. Although the 10 millimeter gap is not a problem in processing, high pressure, Supercritical cleaning co-solvents or other matter can migrate into this 10 millimeter gap between the wafer support surface 12 and the outer bottom edge 97 and condense therebetween, as shown by the arrows in FIG. 1B. Condensation of co-solvents within the 10 millimeter gap can cause a build up of condensed matter on the vacuum chuck or wafer. In addition, the condensed matter can create residue onto the underside 98 of the wafer as well as on the wafer support surface 12 which can cause alignment problems in subsequent operations. Further, the condensed matter can contaminate the wafer 99 and the processing chamber as well as prevent easy removal of the wafer from the chuck after processing of the wafer has completed.

What is needed is a vacuum chuck which is configured to hold the wafer and prevent co-solvents or other matter involved in processing from migrating in between the wafer and the wafer support surface during processing.

### SUMMARY OF THE INVENTION

In one aspect of the invention, a vacuum chuck has a concave wafer platen configured to force the wafer into intimate contact with the wafer platen and provide a seal therebetween when high pressure is applied to the wafer. The wafer is in an engaged position with the wafer platen when the high pressure is applied to the wafer. The underside of the wafer is held in intimate contact with the wafer platen by the high pressure. The vacuum chuck further comprises a groove configured in the wafer platen which applies vacuum to the underside of the wafer. The vacuum chuck further comprises a set of pins which is configured in the wafer platen. The pins are moveable between a first position and a second position, wherein the wafer is easily removeable from the wafer platen when the pins are in the first position. The underside of the wafer is configured to be roughened, thereby allowing the wafer to automatically disengage from the wafer platen when the high pressure is terminated. Alternatively, the underside of the wafer has a smooth surface. The vacuum chuck further comprises a plenum coupled to a pressure regulator which provides pressure for a predetermined amount of time between the wafer and the vacuum chuck, whereby the pressure disengages the wafer from the engaged position. The vacuum chuck further comprises a plurality of protrusions which extend vertically from the wafer platen and restrict any lateral movement of the wafer.

Another aspect of the invention is directed to a vacuum chuck for holding a wafer during processing. The vacuum chuck comprises a recessed area, wherein a portion of the recessed area has a concave surface that is configureable to be in intimate contact with a portion of the wafer under high pressure. High pressure applied to the wafer forms a sealable engagement between the portion of the wafer and the recessed area. The underside of the wafer is roughened, thereby allowing the wafer to automatically disengage from the recessed area when the high pressure is terminated. Alternatively, the underside of the wafer has a smooth surface. The recessed area has a depth dimension that is equivalent and alternatively smaller than a thickness dimension of the wafer. The vacuum chuck further comprises a groove configured in the recessed area which applies vacuum to the underside of the wafer. The vacuum chuck further comprises a set of pins which is configured in the recessed area. The pins are moveable between a first position and a second position such that the wafer is easily removeable from the recessed area when the pins are in the first position. The vacuum chuck further comprises a plenum that is configured within and coupled to a pressure regulator which provides pressure for a predetermined amount of time between the wafer and the vacuum chuck to disengage the wafer from the recessed area. The vacuum chuck comprises a plurality of protrusions which extend vertically from the recessed area and restrict any lateral movement of the wafer.

Another aspect of the invention is directed to a method of holding a wafer having a wafer dimension during processing. The method comprises the steps of: providing a vacuum chuck having a wafer platen for receiving the wafer, wherein at least a portion of the wafer platen has a concave surface. The method also comprises positioning the wafer onto the vacuum chuck. The method also comprises applying high pressure to the wafer, wherein the high pressure forces at least a portion of the wafer into intimate contact and sealable engagement with the concave surface. The method also comprises processing the wafer under high pressure. The method comprises applying high pressure to the wafer, wherein the high pressure forces an outer edge of the wafer into sealable engagement with the wafer platen. The sealable engagement prevents matter from entering between the outer edge of the wafer and the wafer platen. The step of positioning further comprises lowering the wafer onto the vacuum chuck until the portion of the outer edge of the wafer is in contact with the wafer platen. The step of applying high pressure further comprises applying vacuum to the underside of the wafer. The vacuum forces an underside of the wafer into intimate contact with the wafer platen. The method further comprises the step of terminating the high pressure applied to the wafer. The method further comprises the step of removing the wafer from the vacuum chuck. Preferably, the step of removing the wafer further comprises automatically disengaging the wafer from the wafer platen. Alternatively, the step of removing the wafer further comprises applying pressure between the wafer and the vacuum chuck for a predetermined amount of time and actuating a means for lifting the wafer from the wafer platen. The alternative step of removing also includes terminating the pressure that is applied between the wafer and the vacuum chuck before the means for lifting comes into contact with the underside of the wafer and lifting the wafer off of the wafer platen. The method further comprises the step of raising the wafer off of the vacuum chuck after the portion of the outer edge of the wafer is in contact with the top surface of the chuck.

Other features and advantages will be apparent to one skilled in the art from the description and discussion below.

### BRIEF DESCRIPTION OF THE DRAWINGS

FIG. 1A illustrates a perspective view of a schematic showing a prior art vacuum chuck.

FIG. 1B illustrates a side view schematic of the prior art vacuum chuck with wafer position thereon.

FIG. 2 illustrates a perspective view of a preferred vacuum chuck in accordance with the present invention.

FIG. 3A illustrates a side view schematic of the preferred vacuum chuck with a wafer in the raised position in accordance with the present invention.

FIG. 3B illustrates a side view schematic of the preferred vacuum chuck with the wafer resting thereon in accordance with the present invention.

FIG. 3C illustrates a side view schematic of the preferred vacuum chuck with the wafer in the seated, engaged position in accordance with the present invention.

FIG. 4 illustrates a side view schematic of the preferred vacuum chuck with the pressure plenum in accordance with the present invention.

FIG. 5 illustrates a flow chart of the processing procedure utilizing the vacuum chuck in accordance with the present invention.

FIG. 6 illustrates a flow chart of the processing procedure utilizing the vacuum chuck in accordance with the present invention.

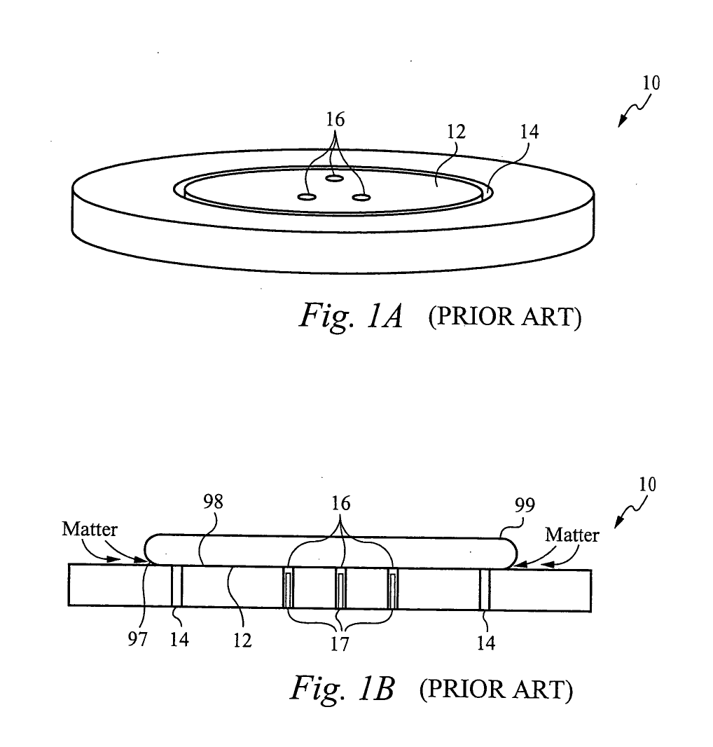

### DETAILED DESCRIPTION OF THE PRESENT INVENTION

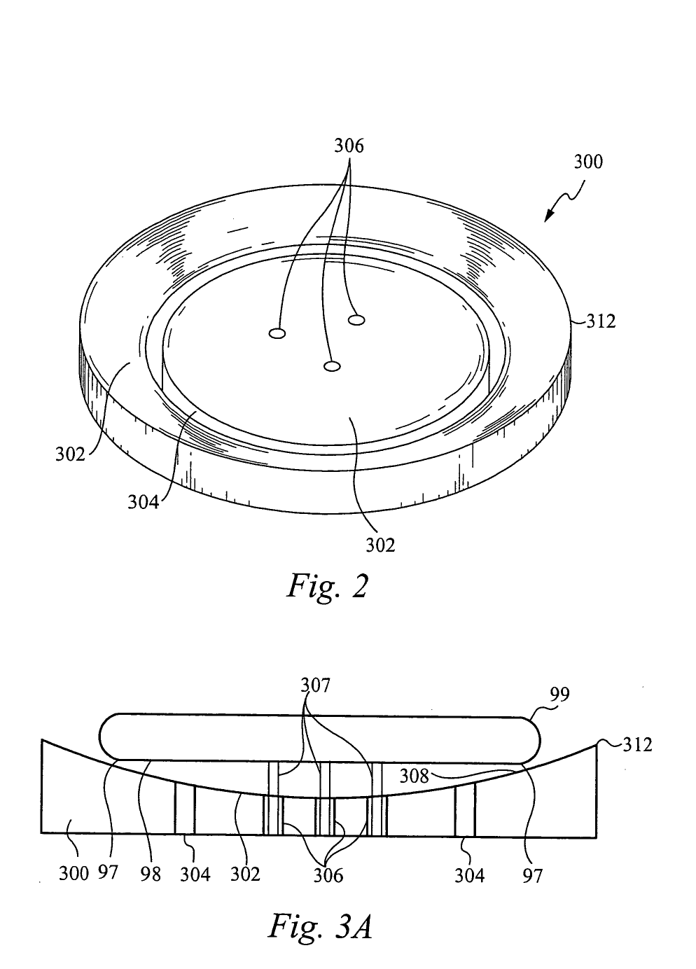

FIG. 2 illustrates a perspective view of the preferred vacuum chuck in accordance with the present invention. As shown in FIG. 2, the preferred vacuum chuck 300 of the present invention has an outer surface 312 and includes a wafer platen 302, a vacuum groove 304 and a set of raising/lowering pins 306 which are disposed near the center of the wafer platen 302. The vacuum chuck 300 preferably holds wafers having a 200 millimeter diameter. Alternatively, the vacuum chuck 300 is for holding wafers having a 300 millimeter or other sized diameter. It should be noted that the figures herein show the features of the present invention in exaggerated fashion to adequately describe and explain the present invention and are thereby not to scale. Preferably, the vacuum chuck of the present invention is utilized in holding Silicon wafers. However, it is apparent to one skilled in the art that the wafers are alternatively made from modified Silicon or any other materials having an appropriate elasticity to deform and undergo the appropriate strain in response to the high pressure applied thereto is contemplated.

The preferred vacuum chuck 300 of the present invention includes at least one vacuum groove 304 as shown in FIG. 2. The vacuum groove 304 has a diameter which is smaller than the diameter of the wafer 99 which is being processed under the high pressure conditions. In addition, the vacuum groove 304 has a minimum depth of 0.050 inch and a width range of 0.010-0.030 inches. Other dimensions of the vacuum groove 304 inside and outside of this range are contemplated, however. Alternatively, more than one vacuum groove is configured on the wafer platen 302, whereby the multiple vacuum grooves are concentrically formed from the center of the wafer platen 302. It should be noted, however, that the largest diameter vacuum groove 304 is equivalent to the outer diameter of the semiconductor wafer, such that the semiconductor wafer is sufficiently held on the wafer platen 302 and the force caused by the vacuum applied at the vacuum region 304 is not compromised. A vacuum producing device (not shown) is coupled to the vacuum groove 304 and produces a suction force that is applied via the vacuum groove 304 to the bottom surface or underside 98 of the wafer 99. The suction force applied via the vacuum plenum 310 to the bottom surface 98 of the wafer 99 aids in securing the wafer 99 to the holding region 306. Alternatively, multiple vacuum ports and lines are used and are coupled to the vacuum groove 304.

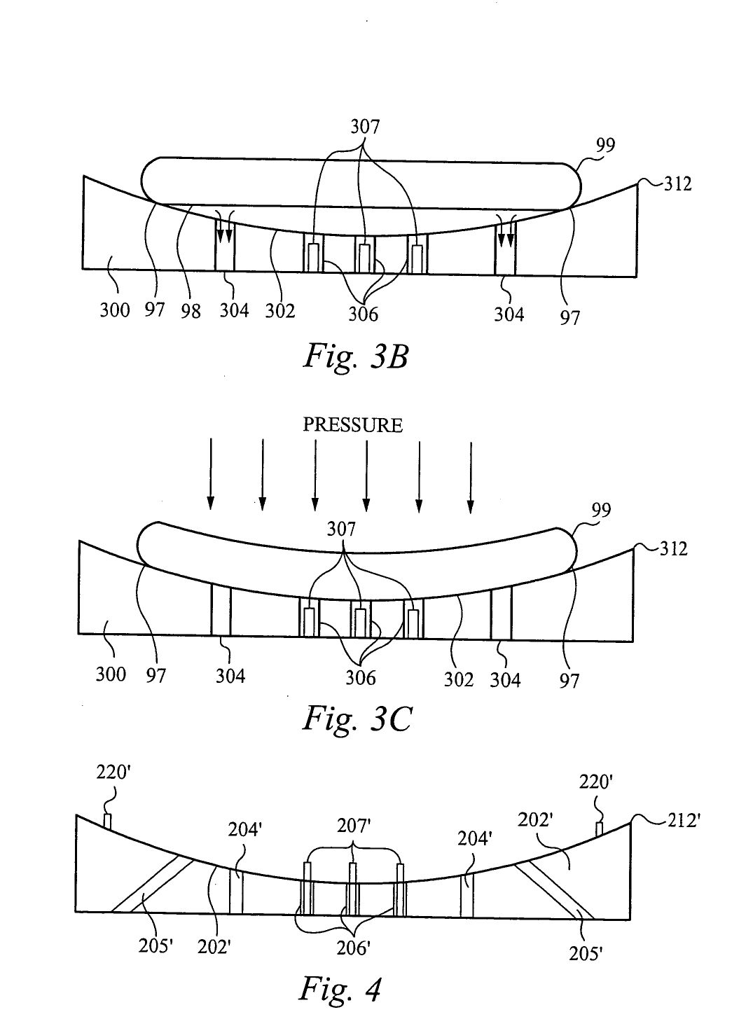

As shown in the figures, the vacuum chuck 300 includes a set of pins 307 positioned within the pin apertures 306. The pins vertically move between a retracted position, as shown in FIGS. 3B and 3C, and an extended position, as shown in FIG. 3A. In the extended position, the set of pins 307 are in contact with the underside 98 of the wafer 99 and support the wafer 99 above the vacuum chuck 300, as shown in FIG. 3A. The pins 307 are preferably in the extended position before and after the wafer is processed in the processing chamber. In the retracted position, the pins 307 are positioned within the pin apertures 306 and are not in contact with the underside 98 of the wafer 99, as shown in FIGS. 3B and 3C.

As shown in FIG. 3C, the wafer platen 302 of the vacuum chuck 300 is for receiving and holding the underside 98 of the wafer 99 during processing. Preferably, the wafer platen 102 has a polished, smooth surface. Alternatively, the wafer platen 102 has a roughened surface. In the preferred embodiment, the wafer platen 302 has a curved surface which traverses the vacuum chuck 300 as an interface surface with the wafer 99 and has a dished or concave surface, as shown in FIGS. 2 and 3A-3C. With respect to the recessed area of the vacuum chuck, the outer surface 312 of the vacuum chuck 300 has a height which is greater than the middle portion of the wafer platen 302, as shown in FIGS. 2 and 3A-3C. In particular, the outer surface 312 is preferably at a height of 0.010 inches above the middle or center portion wafer platen 302. The distance between the outer surface 312 and the center of the concave portion of the recessed area is preferably larger than the thickness of the wafer. Alternatively, the distance between the outer surface 312 and the center of the concave portion of the recessed area is substantially equivalent to the thickness of the wafer. Alternatively, the outer surface 312 is at any other appropriate height with respect to the wafer platen 302. Although the wafer platen in FIG. 2 is shown to be completely concave, it is understood that the area of the platen which is configured to interface with the underside of the wafer is concave. Therefore, it is not necessary that the entire recessed are be concave.

The curved, dished configuration of the wafer platen 302 effectively provides a seal between the wafer 99 and the vacuum chuck 300 under high pressure conditions. In addition to the sealing capabilities of the curved wafer platen 302, the concave wafer platen 302 preferably assists in automatically disengaging the wafer 99 from the seated position when high pressure is no longer present in the chamber (not shown) as discussed below. When high pressure forces are applied from above and/or below the wafer 99, the wafer 99 undergoes a residual strain and deforms to take the shape of the curved wafer platen 302, as shown in FIG. 3C. Thus, under applied high pressure as shown in FIG. 3C, the wafer 99 is in the seated, engaged position, whereby the underside 98 as well as the bottom edge 97 of the wafer 99 come into or is in intimate contact with the wafer platen 302. The deformation of the wafer 99 caused by the high pressure forces generates a seal between the wafer 99 and the wafer platen 302. In particular, the seal is created because the bottom edge 97 of the wafer 99 conforms and mates with the curved wafer platen 302 when the wafer 99 is deformed under high pressure. Thus, the seal created between the bottom edge 97 of the wafer 99 and the wafer platen 302 allows no matter, such as co-solvents or other fluids to migrate or enter between the wafer 99 and the platen 302 during processing. The seal is temporary in that the wafer 99 preferably no longer stays in intimate contact with the curved wafer platen 302 after pressure is terminated.

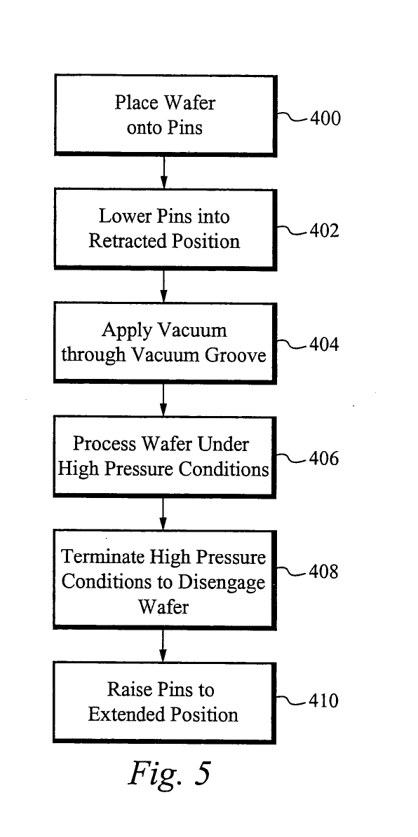

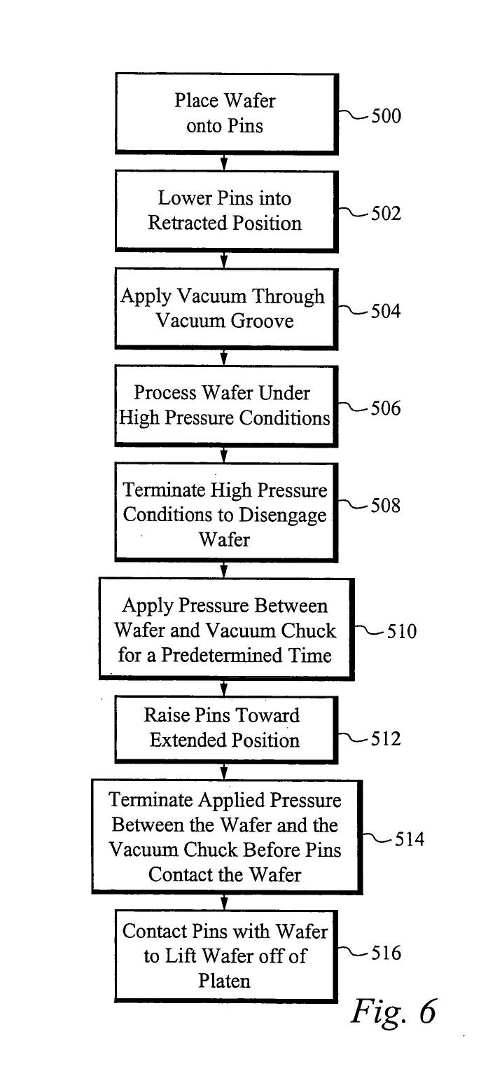

FIG. 3A illustrates a side view schematic of the preferred vacuum chuck 300 with the wafer 99 in the raised position in accordance with the present invention. In addition, FIG. 3B illustrates a side view schematic of the preferred vacuum chuck with the wafer 99 resting thereon in the unengaged position in accordance with the present invention. Further, FIG. 3C illustrates a side view schematic of the alternative vacuum chuck with the wafer 99 in the seated engaged position in accordance with the present invention. Additionally, FIG. 5 illustrates a flow chart of the processing procedure utilizing the vacuum chuck of the preferred embodiment with regard to FIGS. 3A-3C. It should be noted that the process discussed in relation to FIG. 5 is also applicable to the other embodiments discussed below.

In the preferred operation, the set of pins 307 are initially in the extended position, as shown in FIG. 3A, whereby the wafer 99 is placed on top of the pins 307 after being inserted into the cleaning chamber (step 400). Preferably, the pins 307 extend at a height such that the wafer 99 does not touch the wafer platen 302 as shown in FIG. 3A while the pins 307 are extended. Thus, the pins preferably extend above a height of 0.010 inches. Alternatively, the pins extend at a height such that a portion of the underside 98 of the wafer 99 is touching the wafer platen 302 while the pins 307 are extended.

Once the wafer is ready to be processed, the pins 307 are actuated and lowered toward the retracted position (step 402), as shown in FIG. 3B. After the pins 307 are lowered into the retracted position, the outer edges of the wafer 99 come into contact with the wafer platen, as shown in FIG. 3B. As shown by the arrows in FIG. 3B, vacuum is then preferably applied via the vacuum grooves 304 between the underside 98 of the wafer 99 and the wafer platen 302 (step 404). Preferably, the pressure applied via the vacuum grooves 304 is initially greater than the pressure in the chamber as well as the pressure above the wafer 99. The pressure differential between the underside 98 of the wafer 99 and the top surface of the wafer 99 thereby preferably forces the wafer 99 into the seated, engaged position, as shown in FIG. 3C. It is preferred that the processing chamber is then pressurized, whereby high pressure is applied to the top side of the wafer 99, as shown by the arrows in FIG. 3C. It is also preferred that vacuum is no longer applied via the vacuum grooves 304 after the chamber is pressurized. Alternatively, the vacuum does not pull the wafer 99 into the seated position but merely holds the wafer steady on the platen 302 while the chamber is pressurized.

In the seated, engaged position, as shown in FIG. 3C, the underside 98 as well as the bottom edge 97 of the wafer 99 is in complete, intimate contact with the wafer platen 302 as shown in FIG. 3C. In particular, the concave shape of the wafer platen 302 as well as the stress characteristics of the wafer 99 forces the wafer 99 to deform and thereby conform to the concave shape of the wafer platen 302. The slight deformation of the wafer 99 under high pressure forces the bottom edge 97 of the wafer 99 to mate with the concave wafer platen surface 302. In addition, the slight deformation of the wafer 99 under high pressure forces the underside 98 of the wafer 99 to be in intimate contact with the wafer platen 302.

The wafer 99 is then processed within the processing chamber preferably under high pressure or Supercritical conditions (step 406). The intimate contact between the wafer 99 and the wafer platen 302 generates the seal as discussed above. The seal in between the bottom edge 97 of the wafer 99 and the wafer platen 302 prevents any fluid matter, such as a cleaning chemical, from migrating in between the wafer 99 and the wafer platen 302 during processing. Therefore, the bottom edge 97 and underside 98 of the wafer 99 effectively maintains dryness throughout processing.

Once the processing of the wafer 99 is completed, the pressure applied to the wafer 99 in the processing chamber terminates (step 408). Thus, the processing chamber is vented and returns to ambient pressure. The absence of high pressure applied to the wafer 99 allows the residual strain within the wafer 99 material to relax, whereby the wafer 99 effectively restores itself to its natural shape as shown in FIG. 3B. Preferably, the concave surface of the wafer platen 302 as well as the natural shape of the wafer 99 cause the underside 98 and bottom edge 97 of the wafer 99 to no longer be in intimate contact with the wafer platen 302. Thus, the combination of these effects causes the wafer 99 to disengage or “pop up” from the seated, engaged position and momentarily rest on the wafer platen 302, as shown in FIG. 3B. Once the applied high pressure wafer 99 is terminated, the pins 307 are again raised to lift the wafer 99 off of the vacuum chuck, as shown in FIG. 3A (step 410). This raising of the wafer 99 off of the wafer platen 302 prevents cleaning co-solvents from coming into contact with the underside 98 of the wafer 99 after processing.

As stated above, the vacuum chuck of the present invention can have a roughened or smooth surface. In addition, the preferred and alternative vacuum chucks are configured to hold a wafer 99 having an underside 98 which is roughened. The roughened underside 98 has an effect of aiding the wafer 99 in disengaging from the wafer platen due to the lack of bonding forces holding the wafer 99 together with the wafer platen. Alternatively, the wafer has a smooth underside 98, whereby the intimate contact between the polished underside 98 and the smooth wafer platen surface creates a bond therebetween after the wafer 99 has been subjected to high pressure processing. The bond between the wafer 99 and the wafer platen 202 is strong enough such that the wafer 99 does not automatically disengage or “pop up” from the seated, engaged position on the wafer platen. However, the underside 98 of the wafer 99 alternatively has a smooth surface, whereby the smooth surface of the wafer is in intimate contact with the smooth surface of the wafer platen of the present vacuum chuck.

As shown in FIG. 4, the vacuum chuck 200′ has the concave wafer platen 202′ as in the vacuum chuck 300 in the preferred embodiment and operates in the same manner as the preferred vacuum chuck 300. The vacuum chuck 200′ shown in FIG. 4 includes a pressure plenum 205′ configured within the wafer platen 202′. The pressure plenum 205′ is coupled to a pressure regulator (not shown) and a pressure generator (not shown), such as an air compressor. Preferably, the pressure plenum 205′ is configured on the wafer platen 202′ as one or more pressure grooves 205′, as shown in FIG. 4. Alternatively, the pressure plenum 205′ are distinct apertures which are disposed on the wafer platen 202′ or any other location on the vacuum chuck 200′.

The pressure groove 205′ delivers positive pressure to the underside 98 of the wafer 99 when the wafer 99 is in intimate contact with the wafer platen 202′. The positive pressure is sufficient to disrupt or break the bonding forces holding the wafer 99 and wafer platen 202′ together. Thus, the pressure applied through the pressure groove 205′ in effect applies a small force to slightly disengage the wafer 99 from the wafer platen 202′. The medium which is applied between the wafer 99 and the wafer platen 202′ is compressed air, although any other appropriate medium is alternatively contemplated.

In addition, as shown in FIG. 4, the vacuum chuck 200′ includes several cylindrical stabilizing pins 220′ which are disposed on the wafer platen 202′. In particular, the stabilizing pins 220′ extend approximately 0.025 inches above the wafer platen 202′ and are arranged equidistantly at 45 degrees from the center of the wafer platen 202′. In addition, the stabilizing pins 220′ are placed at a distance from the center of the wafer platen 202′ such that the pins 220′ do not interfere with the placement of the wafer 99. It should be noted that although four stabilizing pins 220′ are described in relation to the vacuum chuck 200′, any number of stabilizing pins 220′ are alternatively contemplated. In addition, the stabilizing pins 220′ extend from the wafer platen 202′ at any other length and are positioned at any angle with respect to the center of the wafer platen 202′. The stabilizing pins 220′ in FIG. 4 restrict the wafer 99 from moving in a lateral direction when the positive pressure is applied to the underside 98 of the wafer 99 through the pressure groove 205′ or before the high pressure is applied to the wafer. Thus, the stabilizing pins 220′ maintain the position of the wafer 99 as the wafer 99 is disengaged from the wafer platen 202′. It is apparent that the stabilizing pins 220′ alternatively have any shape and is not limited to a rectangular pin as shown in FIG. 4. For instance, the stabilizing pins 220′ can include, but not be limited to, a bump, notch, flange, circular cylinder, or any other appropriate shape.

FIG. 5 illustrates a flow chart of the processing procedure utilizing the vacuum chuck 200′ in accordance with the present invention. The following processing procedure is discussed in relation to the vacuum chuck 300 in FIGS. 3A-3C for exemplary purposes and is therefore not limited to the vacuum chuck shown and described hereinafter. However, it is apparent that the processing procedure is applicable to the preferred vacuum chuck (FIG. 2, 3A-3C). In operation, the set of pins 207′ are initially in the extended position, as shown in FIG. 4, whereby the wafer 99 is placed on top of the pins 207′ after being inserted into the cleaning chamber (step 500).

Once the wafer is placed onto the pins 207′, the pins 207′ are lowered into the retracted position (step 502). Vacuum is then applied via the vacuum grooves 204′ between the underside 98 of the wafer 99 and the wafer platen 202′ (step 504). The pressure differential between the underside 98 of the wafer 99 and the top surface of the wafer 99 thereby forces the wafer 99 into the seated position with the wafer platen 202′. As with the vacuum chuck in the above discussed embodiments, the underside 98 and bottom surface 97 of the wafer 99 is in complete, intimate contact with the wafer platen 202′ during processing.

The wafer 99 is then processed within the processing chamber preferably under high pressure conditions (step 506). The seal in between the outer edge of the wafer 99 and the inner wall 212′ prevents any fluid matter, such as a cleaning chemical, from migrating in between the wafer 99 and the chuck 200′ and to the wafer's underside 98 during processing. Once the processing of the wafer 99 is completed, the pressure in the processing chamber terminates (step 508). Thus, the processing chamber is vented and returns to ambient pressure.

In the operation of the vacuum chuck 200′, positive pressure is applied through the pressure plenum 205′ between the underside 98 of the wafer 99 and the wafer platen 202′ for a predetermined amount of time (step 510). Alternatively, positive pressure is applied at any other location between the wafer 99 and the vacuum chuck 200′ to aid in disengaging the wafer 99 from the vacuum chuck 200′. The amount of pressure applied is approximately 2 psi, although other pressures are contemplated. In particular, the positive pressure is applied for approximately 1.5 seconds, although other time durations are contemplated. As stated above, the positive pressure from the pressure plenum 205′ dislodges or disengages the wafer 99 from the wafer platen 202′, thereby allowing the wafer 99 to lifted therefrom. The stabilizing pins 220′ restrict the wafer 99 from laterally moving or gliding while the positive pressure is being applied to the underside 98 of the wafer 99.

In conjunction with the positive pressure being applied through the pressure plenum 205′ between the wafer 99 and the chuck 200′, the pins 207 are actuated and begin to extend toward the extended position (step 512). As the pins 207′ are extended, but before coming into contact with the underside 98 of the wafer 99, the applied positive pressure is terminated (step 514). In particular, the positive pressure through the pressure plenum 205′ is terminated approximately 0.5 seconds after the pins 207′ are actuated to move upward, although other time durations are contemplated. Thereafter, the pins 207′ come into contact with the underside 98 of the wafer 99 and lift the wafer 99 off of the vacuum chuck 200′ (step 516). It should be noted however, that the applied pressure does not need to terminate and thereby may continue to apply pressure through the plenum 205′ to the underside 98 of the wafer 99 with or without the pins 207′ lifting the wafer 99.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

1. A vacuum chuck having an outer edge surface at a first height and a wafer platen for holding a wafer in intimate contact therewith, the wafer platen below the first height and a portion thereof having a substantially concave shape configured to prevent fluid from passing between the wafer platen and an outer edge of the wafer under applied high pressure.

2. The vacuum chuck according to claim 1 wherein at least a portion of the wafer is forced into intimate contact with the wafer platen by the high pressure.

3. The vacuum chuck according to claim 2 wherein the wafer is in an engaged position with the wafer platen when the at least the portion of the wafer is in intimate contact.

4. The vacuum chuck according to claim 1 wherein the applied high pressure causes the wafer to deform and contour with the wafer platen.

5. The vacuum chuck according to claim 1 wherein the applied high pressure causes the outer edge of the wafer to mate with the wafer platen.

6. The vacuum chuck according to claim 1 further comprising a groove for applying vacuum to an underside of the wafer, the groove configured in the wafer platen.

7. The vacuum chuck according to claim 1 further comprising a set of pins configured in the wafer platen, the pins moveable between a first position and a second position, wherein the wafer is easily removeable from the wafer platen when the pins are in the first position.

8. The vacuum chuck according to claim 1 wherein the underside of the wafer is roughened.

9. The vacuum chuck according to claim 1 wherein the underside of the wafer has a smooth surface.

10. The vacuum chuck according to claim 2 further comprising a plenum for providing positive pressure between the wafer and the vacuum chuck, wherein the pressure disengages the wafer from the engaged position, the plenum coupled to a pressure regulator.

11. The vacuum chuck according to claim 1 further comprising a plurality of protrusions for restricting lateral movement of the wafer, wherein the plurality of protrusions extend vertically from the wafer platen.

12. A vacuum chuck for holding a wafer during processing, the vacuum chuck comprising a recessed area, wherein a portion of the recessed area has a concave surface configureable to be in intimate contact with a portion of the wafer under high pressure, wherein high pressure applied to the wafer forms a sealable engagement between the portion of the wafer and the recessed area.

13. The vacuum chuck according to claim 12 wherein an underside of the wafer is forced into intimate contact with the recessed area by the high pressure.

14. The vacuum chuck according to claim 13 wherein an outer edge of the wafer is forced into intimate contact with the recessed area by the high pressure

15. The vacuum chuck according to claim 12 wherein the recessed area has a depth dimension larger than a thickness dimension of the wafer.

16. The vacuum chuck according to claim 12 wherein the recessed area has a depth dimension substantially equivalent to a thickness dimension of the wafer.

17. The vacuum chuck according to claim 13 further comprising a groove for applying vacuum to the underside of the wafer, the groove configured in the recessed area.

18. The vacuum chuck according to claim 12 further comprising a set of pins configured in the recessed area, the pins moveable between a first position and a second position, wherein the wafer is easily removeable from the recessed area when the pins are in the first position.

19. The vacuum chuck according to claim 12 wherein the underside of the wafer is roughened.

20. The vacuum chuck according to claim 12 wherein the underside of the wafer has a smooth surface.

21. The vacuum chuck according to claim 12 further comprising a plenum configured within, the plenum for providing positive pressure between the wafer and the vacuum chuck to disengage the wafer from the recessed area, the plenum coupled to a pressure regulator.

22. The vacuum chuck according to claim 21 wherein the positive pressure is provided for a predetermined time between the wafer and the vacuum chuck.

23. The vacuum chuck according to claim 12 further comprising a plurality of protrusions for restricting lateral movement of the wafer, wherein the plurality of protrusions extend vertically from the recessed area.

24. A method of holding a wafer having a wafer dimension during processing comprising the steps of:
a. providing a vacuum chuck having a wafer platen for receiving the wafer, wherein at least a portion of the wafer platen has a concave surface;
b. positioning the wafer onto the vacuum chuck;
c. applying high pressure to the wafer, wherein the high pressure forces at least a portion of the wafer into intimate contact and sealable engagement with the concave surface; and
d. processing the wafer under high pressure.

25. The method of holding according to claim 24 wherein the step of applying high pressure further comprises applying a vacuum to the underside of the wafer, wherein the vacuum forces an underside of the wafer into intimate contact with the wafer platen.

26. The method of holding according to claim 24 wherein the sealable engagement prevents matter from entering between the outer edge of the wafer and the wafer platen.

27. The method of holding according to claim 24 further comprising the step of terminating the high pressure applied to the wafer.

28. The method of holding according to claim 27 further comprising the step of removing the wafer from the vacuum chuck.

29. The method of holding according to claim 28 wherein the step of removing the wafer further comprises automatically disengaging the wafer from sealable engagement with the wafer platen after the high pressure terminates.

30. The method of holding according to claim 29 further comprising the step of raising the wafer off of the vacuum chuck.

31. The method of holding according to claim 28 wherein the step of removing the wafer further comprises:
a. applying pressure between the wafer and the vacuum chuck for a predetermined amount of time;
b. actuating means for lifting the wafer from the wafer platen;
c. terminating the pressure applied between the wafer and the vacuum chuck before the means for lifting comes into contact with the underside of the wafer; and
d. lifting the wafer off of the wafer platen.
